(19) United States
(12) Patent Application Publication
(10) Pub. No.: US 2026/0219904 A1
(43) Pub. Date: Jul. 30, 2026

(54) METHOD AND SYSTEM FOR RENDERING MULTIPLE INSTANCES OF A FORM WITHIN A SINGLE BROWSER

(71) Applicant: Michael Till, San Antonio, TX (US)

(72) Inventor: Michael Till, San Antonio, TX (US)

(21) Appl. No.: 19/039,221

(22) Filed: Jan. 28, 2025

(51) Int. Cl. G06F 9/451; G06F 9/54

(52) U.S. Cl. CPC G06F 9/452; G06F 9/542

(57) ABSTRACT

A system for simultaneous rendering of multiple instances of a non-modal form within a single browser based on a shared database including a processor of a window renderer server (WRS) node configured to access a shared database and a memory on which are stored machine-readable instructions that when executed by the processor, cause the processor to:
detect a trigger event activated by a user comprising trigger event parameters; parse out the trigger event parameters; generate a collection of instances of the non-modal form based on the trigger event parameters; instantiate windows renderer entities corresponding to the collection of the instances of the non-modal form; and display the collection of the instances of the non-modal form to the user.

### FIELD OF DISCLOSURE

The present disclosure generally relates to rendering forms on user computing device, and more particularly, to a system and method for real-time rendering of multiple instances of a non-modal form within a single browser.

### BACKGROUND

Traditionally, “One Page At a Time” (OPAT) methodology is used in existing browser-based Enterprise Resource Planning (ERP) systems.

Browser-based Enterprise Resource Planning (ERP) systems that operate “one page at a time” come with several potential disadvantages. The limitations associated with this approach are:

### 1. Reduced User Experience (UX)

Limited Interactivity: Navigating through multiple pages for different operations can disrupt the workflow, making the user experience slower and less intuitive compared to modern single-page applications (SPAs) or desktop-like interfaces. Frequent Page Reloads: Each action requiring a new page load can lead to delays, particularly in scenarios requiring fast and frequent updates (e.g., inventory or real-time tracking). Fragmented Navigation: Constant switching between pages might confuse users and increase the learning curve for employees unfamiliar with the system.

### 2. Performance Concerns

Increased Load Times: Loading entire pages repeatedly can slow down performance, especially for users with slower internet connections or when the ERP system has a heavy data load. Server Strain: Each page request involves a round trip to the server, increasing the load on the server and potentially slowing down response times during peak usage.

### 3. Limited Scalability

Data Handling: Handling large datasets is less efficient when data needs to be reloaded for each page instead of being dynamically updated on a single screen. Customization Challenges: Integrating advanced features like Dashboards or real-time analytics becomes more cumbersome without a modern, dynamic interface.

### 4. Poor Integration with Modern Tools

Lack of Real-Time Updates: Many browser-based systems that load one page at a time lack real-time features, such as WebSockets or push notifications, which are vital for modern business operations.

Difficulty with API-Driven Features: Integrating third-party tools and services might be less seamless compared to SPAs or desktop-like interfaces.

### 5. Lower Productivity

Time Wasted in Navigation: Employees spend more time navigating between screens instead of focusing on productive tasks. Higher Error Rates: The back-and-forth navigation increases the likelihood of errors, such as re-entering incorrect data or missing updates.

### 6. Outdated Design Perception

Competitiveness: Businesses may perceive the ERP system as outdated, which could affect adoption rates among employees and stakeholders. User Expectation: With modern systems offering dynamic, single-page interfaces, the one-page-at-a-time model might not meet current user expectations.

### 7. Offline/Low Bandwidth Inefficiency

Dependency on Connectivity: Each page load requires stable internet, making the system less reliable in low-bandwidth or offline scenarios. Caching Issues: Unlike SPAs, browser-based systems with multiple page loads often struggle to effectively cache data, leading to inefficiencies.

Accordingly, automated system and method for rendering of multiple instances of a non-modal form within a single browser are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for simultaneous rendering of multiple instances of a non-modal form within a single browser based on a shared database including a processor of a window renderer server (WRS) node configured to access a shared database and a memory on which are stored machine-readable instructions that when executed by the processor, cause the processor to: detect a trigger event activated by a user comprising trigger event parameters; parse out the trigger event parameters; generate a collection of instances of the non-modal form based on the trigger event parameters; instantiate windows renderer entities corresponding to the collection of the instances of the non-modal form; and display the collection of the instances of the non-modal form to the user.

Another embodiment of the present disclosure provides a method that includes one or more of: detecting a trigger event activated by a user comprising trigger event parameters; parsing out the trigger event parameters; generate a collection of instances of the non-modal form based on the trigger event parameters; instantiating windows renderer entities corresponding to the collection of the instances of the non-modal form; and displaying the collection of the instances of the non-modal form to the user.

Another embodiment of the present disclosure provides a computer-readable medium including instructions for: detecting a trigger event activated by a user comprising trigger event parameters; parsing out the trigger event parameters; generate a collection of instances of the non-modal form based on the trigger event parameters; instantiating windows renderer entities corresponding to the collection of the instances of the non-modal form; and displaying the collection of the instances of the non-modal form to the user.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of a system for rendering of multiple instances of a non-modal form within a single browser consistent with the present disclosure;

FIG. 1B illustrates a process for rendering of multiple instances of a non-modal form within a single browser consistent with the present disclosure;

FIG. 2 illustrates a network diagram of a system including detailed features of a Window Renderer Server (WRS) node consistent with the present disclosure;

FIG. 3A illustrates a flowchart of a method for rendering of multiple instances of a non-modal form within a single browser consistent with the present disclosure;

FIG. 3B illustrates a further flowchart of a method for rendering of multiple instances of a non-modal form within a single browser consistent with the present disclosure;

FIG. 4 illustrates a block diagram of a system including a computing device for performing the method of FIGS. 3A and 3B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of rendering of multiple instances of a non-modal form within a single browser, embodiments of the present disclosure are not limited to use only in this context.

The present disclosure provides a system, method and computer-readable medium for rendering of multiple instances of a non-modal form within a single browser based on a shared database. In one embodiment, the system overcomes the limitations of existing methods of rendering multiple forms by leveraging the capabilities of the form window renderers using form collections. The disclosed approach offers a significant improvement over existing solutions discussed above in the background section.

In one embodiment, the system and method introduce an innovative approach to browser-based software applications, particularly in the realm of Enterprise Resource Planning (ERP) systems. The core innovation lies in its non-modal functionality, allowing multiple data entry forms to be opened, edited, and saved simultaneously within a browser environment. This represents a significant departure from the traditional “One Page At a Time” (OPAT) methodology discussed above. The primary goal is to bring multi-tasking capabilities to web applications, a feature previously limited to desktop software. The system's key features include simultaneous form handling, real-time data sharing between forms and the main application, and a non-modal design that allows users to switch between tasks without losing context. This multi-tasking capability is particularly beneficial for Business Management and Accounting software systems. The disclose embodiments overcome several limitations of current browser-based applications, most notably restricting one active page or form at a time. It enables users to compare and contrast multiple data sets in real time, a functionality not available in market-leading ERP systems (e.g., QuickBooks™ and NetSuite™).

From a technical standpoint, the discloses system achieves desktop-like functionality within the constraints of a web browser, addressing a long-standing challenge in web application development. The system maintains a single, shared database despite the multi-form interface, ensuring data consistency across all open forms and the main application. This approach to managing multiple active forms without page reloads, or form submissions represents a novel solution to the limitations of HTTP's stateless nature in web applications.

To enable the non-modal environment, each data entry form or page is assigned an individual ID at the time it is opened. The database is then queried via APIs for all relevant data associated with the record being accessed for modification. These data stores are referenced throughout the period of user interaction with the record. Data collected may be stored:
In browser memory stores made of a series of data collection objects;
In global variables for interactions with multiple objects simultaneously;
Within the database for use in data management in multi-user environments;
On modal forms for controlling specific events and constraints.

The collected data may be used for:
For limiting access to various features to specific users;
For preventing data entry conflicts between multiple users;
For validating data editing capabilities and limitations;
To enable form appearance and behavior modifications based on data values;
To enable multiple copies of the same forms to be utilized simultaneously;
For communicating certain instructions to the main application shell.

To fully enable the opening and use of an unlimited number of individual data driven input and edit forms simultaneously the data stores must contain static information, meaning certain settings that will remain unchanged during the session. In addition, certain data stores must be refreshed during the session when necessary.

Events may be triggered by on-screen activities performed by the user. Modal form data is then compared with cached data which enables the database to be updated accurately. Refresh actions are controlled by the non-modal forms. As data is changed and saved, global form object mappings are accessed so that the only data displays that are refreshed are those related to the newly added or edited non-modal data.

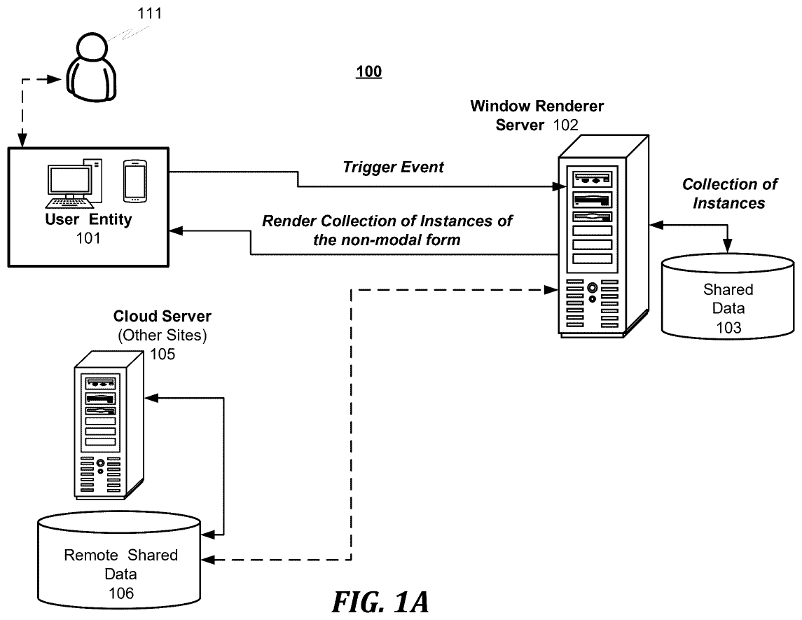

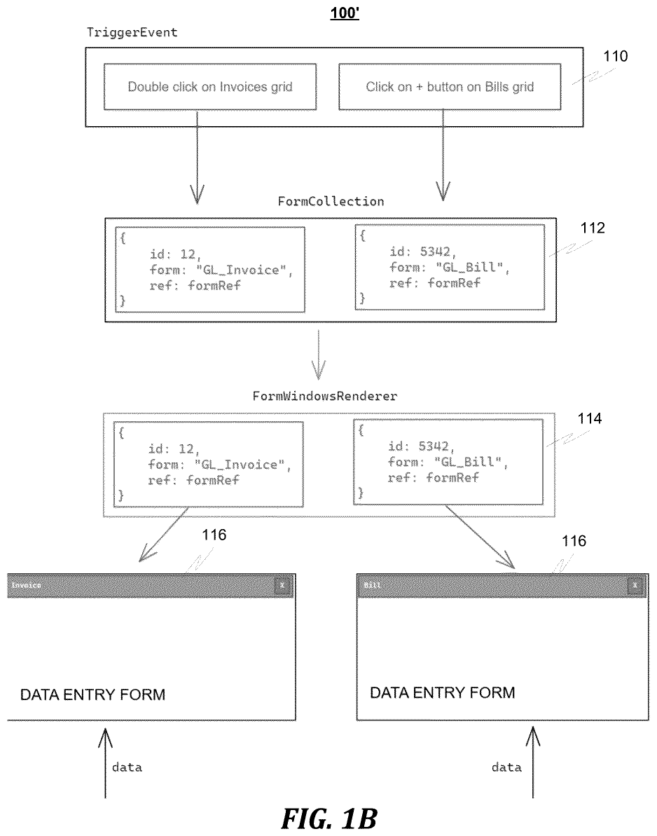

FIG. 1A illustrates a network diagram of a system for rendering of multiple instances of a non-modal form within a single browser consistent with the present disclosure.

Referring to FIG. 1A, the example network 100 includes the Window Renderer Server (WRS) node 102 connected to the user entity 101 (see FIGS. 1A-B) associated with a user 111 to receive the trigger event data 202 including trigger event parameters.

The WRS node 102 may detect a trigger event from the user entity 101 activated by a user 111. The trigger event may include trigger event parameters that may be parsed out by the WRS node 102. The WRS node 102 may generate a collection of instances of the non-modal form based on the trigger event parameters received from the user entity 101. The WRS node 102 may instantiate windows renderer entities corresponding to the collection of the instances of the non-modal form that may be derived from the shared database 103 or 106. Finally, the WRS node 102 may render the collection of the instances of the non-modal form to the user 111 via the user entity 101.

As discussed above, shared data 103 from a local or 106 from remote database residing on a cloud server 105 may be retrieved to connect the collection of the instances of the non-modal form to the shared database. While this example describes in detail only one WRS node 102, multiple such nodes may be connected to the network.

FIG. 1B illustrates a process for rendering of multiple instances of a non-modal form within a single browser consistent with the present disclosure.

Referring to FIG. 1B, the exemplary process 100′ includes detecting a trigger event at step 110 activated by a user and including trigger event parameters. At step 112, the process generates form collections identified by form IDs. At step 114, form window renderers are instantiated to render the data entry forms 116 to a user.

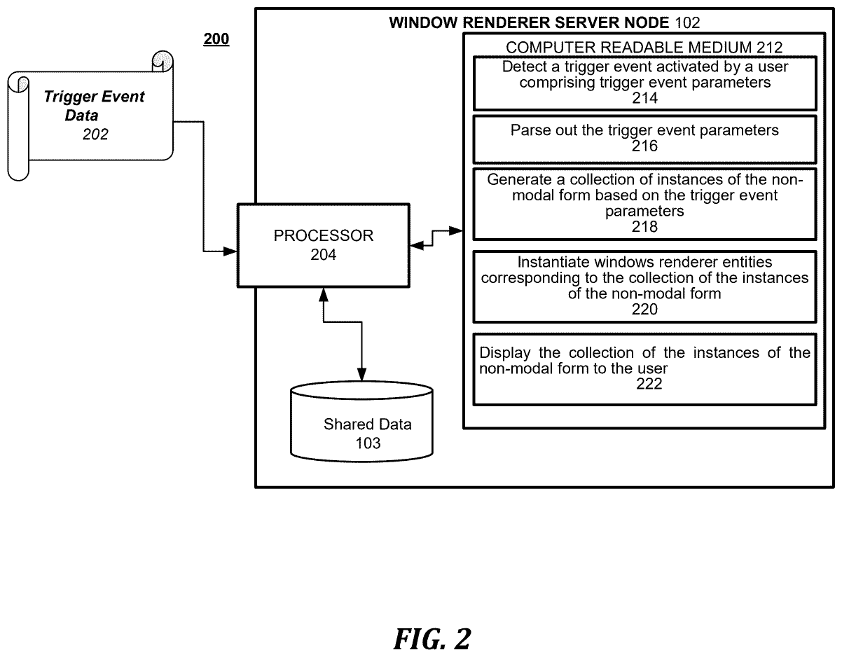

FIG. 2 illustrates a network diagram of a system including detailed features of a Window Renderer Server (WRS) node consistent with the present disclosure.

Referring to FIG. 2, the example network 200 includes the WRS node 102 connected to the user entity 101 (see FIGS. 1A-B) associated with a user 111 to receive the trigger event data 202 including trigger event parameters.

As discussed above, shared data 103 from a local or 106 from remote database residing on a cloud server 105 may be retrieved to connect the collection of the instances of the non-modal form to the shared database. While this example describes in detail only one WRS node 102, multiple such nodes may be connected to the network. It should be understood that the WRS node 102 may include additional components and that some of the components described herein may be removed and/or modified without departing from a scope of the WRS node 102 disclosed herein. The WRS node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the WRS node 102 may include multiple processors, multiple cores, or the like, without departing from the scope of the WRS node 102 system.

The WRS node 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to detect a trigger event activated by a user 111 comprising trigger event parameters (see FIG. 1A-B). The processor 204 may fetch, decode, and execute the machine-readable instructions 216 to parse out the trigger event parameters. The processor 204 may fetch, decode, and execute the machine-readable instructions 218 to generate a collection of instances of the non-modal form based on the trigger event parameters. The processor 204 may fetch, decode, and execute the machine-readable 220 to instantiate windows renderer entities corresponding to the collection of the instances of the non-modal form.

The processor 204 may fetch, decode, and execute the machine-readable instructions 222 to display the collection of the instances of the non-modal form to the user 111.

Note that the processor 204 may analyze data from the data collection objects for any of: limiting access to various features to specific users; preventing data entry conflicts between multiple users; and validating data editing capabilities and limitations.

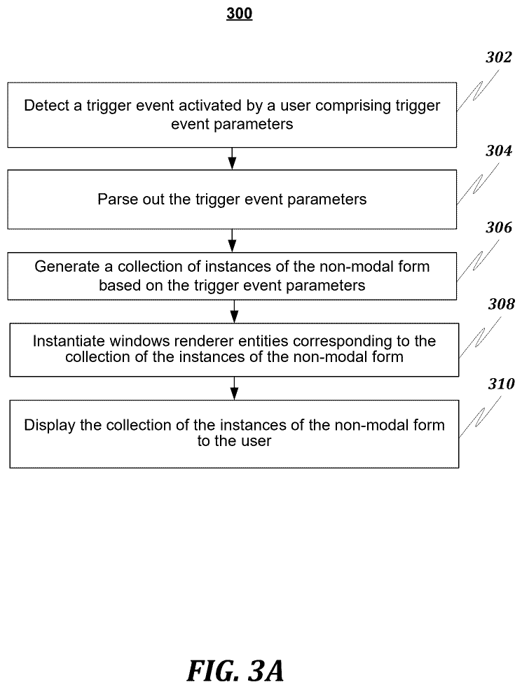

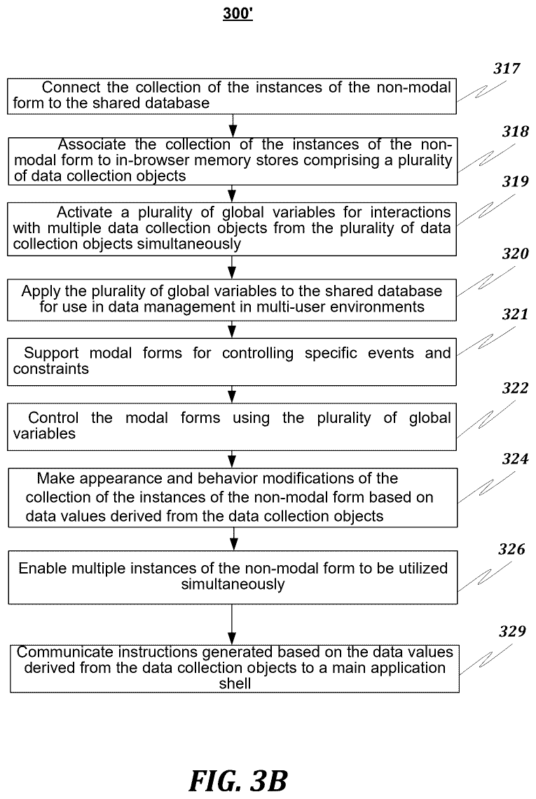

FIG. 3A illustrates a flowchart of a method for rendering of multiple instances of a non-modal form within a single browser consistent with the present disclosure.

Referring to FIG. 3A, the method 300 may include one or more of the steps described below. FIG. 3A illustrates a flow chart of an example method executed by the WRS node 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the WRS node 102 may execute some or all of the operations included in the method 300.

With reference to FIG. 3A, at block 302, the processor 204 may detect a trigger event activated by a user comprising trigger event parameters. At block 304, the processor 204 may parse out the trigger event parameters. At block 306, the processor 204 may generate a collection of instances of the non-modal form based on the trigger event parameters. At block 308, the processor 204 may instantiate windows renderer entities corresponding to the collection of the instances of the non-modal form. At block 310, the processor 204 may display the collection of the instances of the non-modal form to the user.

FIG. 3B illustrates a further flowchart of a method for rendering of multiple instances of a non-modal form within a single browser consistent with the present disclosure.

Referring to FIG. 3B, the method 300′ may include one or more of the steps described below. FIG. 3B illustrates a flow chart of an example method executed by the WRS node 102 (see FIG. 2). It should be understood that method 300′ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the WRS 102 may execute some or all of the operations included in the method 300′.

With reference to FIG. 3B, at block 317, the processor 204 may connect the collection of the instances of the non-modal form to the shared database.

At block 318, the processor 204 may associate the collection of the instances of the non-modal form to in-browser memory stores comprising a plurality of data collection objects. At block 319, the processor 204 may activate a plurality of global variables for interactions with multiple data collection objects from the plurality of data collection objects simultaneously. At block 320, the processor 204 may apply the plurality of global variables to the shared database for use in data management in multi-user environments. At block 321, the processor 204 may support modal forms for controlling specific events and constraints.

At block 322, the processor 204 may control the modal forms using the plurality of global variables. At block 323, the processor 204 may make appearance and behavior modifications of the collection of the instances of the non-modal form based on data values derived from the data collection objects.

At block 324, the processor 204 may enable multiple instances of the non-modal form to be utilized simultaneously. At block 326, the processor 204 may communicate instructions generated based on the data values derived from the data collection objects to a main application shell.

The resulting application product and technology demonstrates a dramatic shift away from current design standards and makes extensive use of the browser's memory capabilities and ability to house instructions for database access to enable an architecture that does not currently exist for browser-based, database driven applications. As discussed above, there are two aspects of current design standards that the invention overcomes.

1. The OPAT (One-page at a time) design that is the hallmark of all browser-based applications. This design standard reduces the user's environment to no more than one screen at a time.

2. The List/Entry/List action is the standard action in browser-based applications. It is derived from a long history of web pages being developed for shopping and with forms taking on those same limiting characteristics. For example, the user views a list of data, then clicks to add/edit a detail of the selected record, whether on a separate webpage or on modal popup form. When the user closes the add/edit form or page the focus is returned to the original list page.

The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

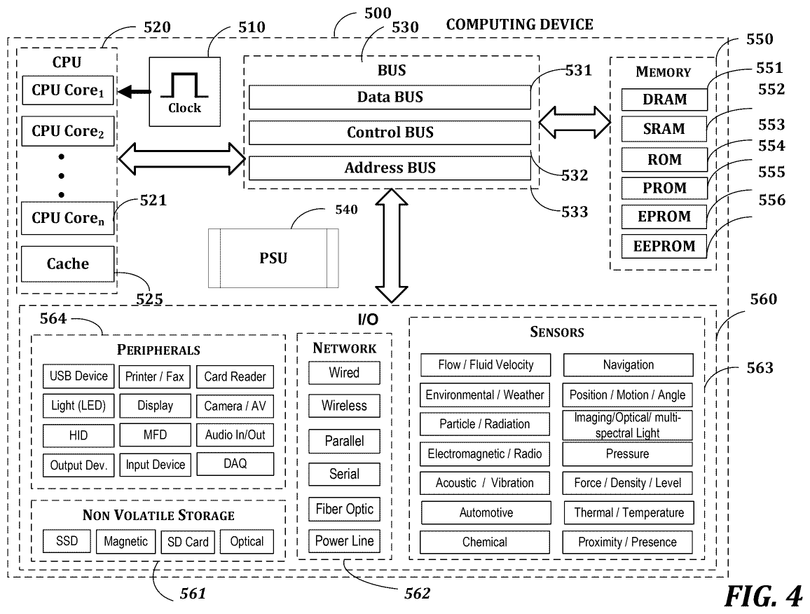

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 4 illustrates an example computing device (e.g., a server node) 500, which may represent or be integrated in any of the above-described components, etc.

FIG. 4 illustrates a block diagram of a system including computing device 500. The computing device 500 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The WRS node 102 (see FIG. 2) may be hosted on a centralized server or on a cloud computing service. Although method 300 has been described to be performed by the WRS node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the WRS node 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of the clock 510 may include dynamic frequency change, where the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big. LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and eXtensible Host Controller Interface (xHCI).

Consistent with the embodiments of the present disclosure, the aforementioned computing device 500 may employ hardware integrated circuits that store information for immediate use in the computing device 500, known to the person having ordinary skill in the art as primary storage or memory 550. The memory 550 operates at high speed, distinguishing it from the non-volatile storage sub-module 561, which may be referred to as secondary or tertiary storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also other purposes in the computing device 500. The memory 550 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programmable (OTP) ROM / Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 550. The non-volatile storage sub-module 561 does not lose data when power is removed and may be two orders of magnitude less costly than storage used in memory modules, at the expense of speed and latency. The non-volatile storage sub-module 561 may comprise a plurality of forms, such as, but not limited to, Direct Attached Storage (WRS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD +RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5[IPv 5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G,5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical WRS sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine /olant/exhaust/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (O2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical WRS sensor, fish counter, frequency domain sensor, WRS detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, WRS meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photo-switch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.
Thermal and temperature sensors, such as, but not limited to, bolometer, bimetallic strip, calorimeter, exhaust WRS temperature gauge, flame detection / pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices used to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input /utput devices that perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller / gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics / sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for simultaneous rendering of multiple instances of a non-modal form within a single browser based on a shared database, comprising:
a processor of a window renderer server (WRS) node configured to access a shared database; and
a memory on which are stored machine-readable instructions that when executed by the processor, cause the processor to:
detect a trigger event activated by a user comprising trigger event parameters;
parse out the trigger event parameters;
generate a collection of instances of the non-modal form based on the trigger event parameters;
instantiate windows renderer entities corresponding to the collection of the instances of the non-modal form; and
display the collection of the instances of the non-modal form to the user.

2. The system of claim 1, wherein the machine-readable instructions that when executed by the processor, cause the processor to connect the collection of the instances of the non-modal form to the shared database.

3. The system of claim 2, wherein the machine-readable instructions that when executed by the processor, cause the processor to associate the collection of the instances of the non-modal form to in-browser memory stores comprising a plurality of data collection objects.

4. The system of claim 3, wherein the machine-readable instructions that when executed by the processor, cause the processor to activate a plurality of global variables for interactions with multiple data collection objects from the plurality of data collection objects simultaneously.

5. The system of claim 4, wherein the machine-readable instructions that when executed by the processor, cause the processor to apply the plurality of global variables to the shared database for use in data management in multi-user environments.

6. The system of claim 5, wherein the machine-readable instructions that when executed by the processor, cause the processor to support modal forms for controlling specific events and constraints.

7. The system of claim 6, wherein the machine-readable instructions that when executed by the processor, cause the processor to control the modal forms using the plurality of global variables.

8. The system of claim 3, wherein the machine-readable instructions that when executed by the processor, cause the processor to analyze data from the data collection objects for any of:
limiting access to various features to specific users;
preventing data entry conflicts between multiple users; and
validating data editing capabilities and limitations.

9. The system of claim 8, wherein the machine-readable instructions that when executed by the processor, cause the processor to make appearance and behavior modifications of the collection of the instances of the non-modal form based on data values derived from the data collection objects.

10. The system of claim 8, wherein the machine-readable instructions that when executed by the processor, cause the processor to enable multiple instances of the non-modal form to be utilized simultaneously.

11. The system of claim 9, wherein the machine-readable instructions that when executed by the processor, cause the processor to communicate instructions generated based on the data values derived from the data collection objects to a main application shell.

12. A method for simultaneous rendering of multiple instances of a non-modal form within a single browser based on a shared database, comprising:
detecting, by a window renderer server (WRS) node, a trigger event activated by a user comprising trigger event parameters;
parsing, by the WRS node, out the trigger event parameters;
generating, by the WRS node, a collection of instances of the non-modal form based on the trigger event parameters;
instantiating, by the WRS node, windows renderer entities corresponding to the collection of the instances of the non-modal form; and
displaying, by the WRS node, the collection of the instances of the non-modal form to the user.

13. The method of claim 12, further comprising connecting the collection of the instances of the non-modal form to the shared database.

14. The method of claim 13, further comprising associating the collection of the instances of the non-modal form to in-browser memory stores comprising a plurality of data collection objects.

15. The method of claim 13, further comprising activating a plurality of global variables for interactions with multiple data collection objects from the plurality of data collection objects simultaneously.

16. The method of claim 15, further comprising applying the plurality of global variables to the shared database for use in data management in multi-user environments.

17. The method of claim 16, further comprising supporting modal forms for controlling specific events and constraints.

18. The method of claim 15, further comprising controlling the modal forms using the plurality of global variables.

19. A non-transitory computer-readable medium comprising instructions, that when read by a processor, cause the processor to perform:
detecting a trigger event activated by a user comprising trigger event parameters;
parsing out the trigger event parameters;
generating a collection of instances of the non-modal form based on the trigger event parameters;
instantiating windows renderer entities corresponding to the collection of the instances of the non-modal form; and
displaying the collection of the instances of the non-modal form to the user.

20. The non-transitory computer-readable medium of claim comprising instructions, that when read by a processor, cause the processor to perform analyzing data from data collection objects for any of:
limiting access to various features to specific users;
preventing data entry conflicts between multiple users; and
validating data editing capabilities and limitations.
